(19) United States
(12) Patent Application Publication
(10) Pub. No.: US 2026/0296649 A1
(43) Pub. Date: Oct. 1, 2026

(54) System for Directing Aircraft Waste Heat for Cargo Compartment Temperature Control and Method

(71) Applicant: The Boeing Company, Arlington, VA (US)

(72) Inventors: Bryce Aaron Tillack, Highlands Ranch, CO (US); Michael Dwayne Williams, Spanaway, WA (US); Brian Conrad Christenson, Arlington, WA (US); Christopher C. Walling, Lynnwood, WA (US)

(21) Appl. No.: 19/090,927

(22) Filed: Mar. 26, 2025

(51) Int. Cl. B64D 13/08; B64D 13/06; B64D 33/10

(52) U.S. Cl. CPC B64D 13/08; B64D 33/10; B64D 2013/0614; B64D 2013/0674

(57) ABSTRACT

An aircraft cargo compartment temperature regulating system configured to increase air temperature by efficiently redirecting and re-purposing waste heat from an aircraft liquid chilling circuit using a heat exchanger to produce a heated airflow directed into an aircraft cargo compartment and methods are disclosed.

### TECHNOLOGICAL FIELD

The present disclosure relates generally to the field of aircraft cargo compartment heating systems. More specifically, the present disclosure relates to the field of regulating the temperature of aircraft cargo compartments.

### BACKGROUND

Aircraft cargo compartments can typically confront large air temperature differentials over various flight phases. That is, pre-flight and post-flight, in warm climates, aircraft cargo compartments can sustain environmental temperatures outside of the aircraft that increase an aircraft cargo compartment air temperature about 100° F. In addition, during flight at high altitudes, the cold environmental temperatures outside of the aircraft can result in cargo compartment air temperatures nearing freezing, or falling below about 30° F.

When a cargo compartment contains perishables, livestock, or other cargo that cannot be allowed to sustain large temperature swings, or that cannot be subjected to freezing temperatures during flight, electric heaters are typically placed in communication with an aircraft cargo compartment air duct, with electrically heated air produced by the electric heaters and introduced into the cargo compartment. The power drain required to produce heated air for use in an aircraft cargo compartment by incorporating one or more electric heaters creates a power draw that can increase aircraft fuel consumption. In addition, the weight of the electric heaters can significantly increase aircraft fuel consumption, decrease aircraft range, potentially decrease passenger capacity count, and otherwise increase aircraft operation cost.

Unless explicitly identified as such, no statement herein is admitted as prior art merely by its inclusion in the Technological Field and/or Background section.

### SUMMARY

A present aspect is directed to an aircraft cargo compartment temperature regulating system for directing waste heat from an aircraft liquid chilling circuit to an aircraft cargo compartment, with the aircraft cargo compartment temperature regulating system comprising an aircraft liquid chilling circuit for providing chilling to a first aircraft region to reduce a localized and/or environmental temperature in the first aircraft region, said aircraft liquid chilling circuit configured to provide absorbed waste heat from the first aircraft region to form a warmed liquid flow in a warmed liquid flow line in the aircraft liquid chilling circuit, a heat exchanger located in line with the aircraft liquid chilling circuit, with the heat exchanger comprising a heat exchanger liquid inlet in communication with the warmed liquid flow line, with the heat exchanger further comprising a cooler liquid heat exchanger outlet in communication with a cooler liquid flow line in the liquid chilling circuit, with the heat exchanger further comprising a heat exchanger air inlet and a heat exchanger warmed air outlet, with the heat exchanger configured to transfer waste heat in the warmed liquid flow to an airflow entering the heat exchanger air inlet, an aircraft cargo compartment air duct in communication with an aircraft cargo compartment, said aircraft cargo compartment air duct further in communication with the heat exchanger warmed air outlet, and with the heat exchanger located upstream of the aircraft cargo compartment air duct.

In another present aspect the aircraft cargo compartment temperature regulating system further comprises at least one air temperature sensor located in the aircraft cargo compartment, a heated airflow valve controller in communication with the air temperature sensor, and a heated airflow valve assembly in communication with the heated airflow valve controller, said heated airflow valve assembly located downstream of the heat exchanger, said heated airflow valve assembly configured to control the release of the warmed airflow from the warmed airflow line into an aircraft cargo compartment air duct in response to a temperature sensed by the at least one air temperature sensor, and in further response to a signal sent by the controller.

In another present aspect, the aircraft cargo compartment temperature regulating system further comprises at least one cargo compartment air temperature sensor located in the aircraft cargo compartment, a liquid valve controller in communication with the cargo compartment air temperature sensor, and a liquid valve assembly in communication with the warmed liquid flow line, with the liquid valve assembly located upstream of the heat exchanger warmed liquid inlet, with the liquid valve assembly further in communication with the liquid valve controller, with the liquid valve assembly configured to control the delivery of a warmed liquid flow from the warmed liquid flow line into the heat exchanger liquid inlet in response to a temperature sensed by the at least one temperature sensor, and in further response to a signal sent by the liquid valve controller to the liquid valve assembly.

In another present aspect, the first aircraft region is at least one of an electronics compartment and a galley compartment.

In another present aspect, liquid chilling circuit circulates a fluid configured to absorb and release a thermal load (e.g., a heat transfer fluid comprising a high thermal conductivity, etc.), said fluid comprising at least one of a propylene glycol mixture, a perfluoropolyether mixture, water, and combinations thereof.

In another present aspect, the heated airflow valve assembly is located within the aircraft cargo compartment air duct.

In another present aspect, at least one of the liquid valve controller and the heated airflow controller is configured to receive an aircraft condition signal, said aircraft condition signal comprising at least one of an aircraft phase of flight signal, an aircraft altitude signal, and an aircraft cargo compartment selected temperature signal.

In another present aspect, waste heat from the air liquid chilling circuit is delivered to the heat exchanger to form a heated airflow responsible for regulating the air temperature of the aircraft cargo compartment.

In another present aspect, the aircraft cargo compartment air duct is not in communication with source of heating comprising with another heat generating assembly, with the heat generating assembly being at least one of an electrical heater, and hot pneumatic heating from an aircraft engine (e.g., a directed bleed airflow, etc.).

Another present aspect is directed to an aircraft cargo compartment in communication with an aircraft cargo compartment temperature regulating system aircraft system for directing waste heat from an aircraft liquid chilling circuit to an aircraft cargo compartment, with the aircraft cargo compartment temperature regulating system comprising an aircraft liquid chilling circuit for providing chilling to a first aircraft region to reduce an environmental temperature in the first aircraft region (e.g., a localized temperature within the first aircraft region), with the aircraft liquid chilling circuit configured to provide absorbed waste heat from the first aircraft region to form a warmed liquid flow in a warmed liquid flow line in the aircraft liquid chilling circuit, a heat exchanger located in line with the aircraft liquid chilling circuit, with the heat exchanger comprising a heat exchanger liquid inlet in communication with the warmed liquid flow line, with the heat exchanger further comprising a cooler liquid heat exchanger outlet in communication with a cooler liquid flow line in the liquid chilling circuit, with the heat exchanger further comprising a heat exchanger air inlet and a heat exchanger warmed air outlet, with the heat exchanger configured to transfer waste heat in the warmed liquid flow to an airflow entering the heat exchanger air inlet, an aircraft cargo compartment air duct in communication with an aircraft cargo compartment, said aircraft cargo compartment air duct further in communication with the heat exchanger warmed air outlet, and with the heat exchanger located upstream of the aircraft cargo compartment air duct.

Another present aspect is directed to an aircraft comprising an aircraft cargo compartment temperature regulating system aircraft system for directing waste heat from an aircraft liquid chilling circuit to an aircraft cargo compartment, with the aircraft cargo compartment temperature regulating system comprising an aircraft liquid chilling circuit for providing chilling to a first aircraft region to reduce an environmental temperature in the first aircraft region, said aircraft liquid chilling circuit configured to provide absorbed waste heat from the first aircraft region to form a warmed liquid flow in a warmed liquid flow line in the aircraft liquid chilling circuit, a heat exchanger located in line with the aircraft liquid chilling circuit, with the heat exchanger comprising a heat exchanger liquid inlet in communication with the warmed liquid flow line, with the heat exchanger further comprising a cooler liquid heat exchanger outlet in communication with a cooler liquid flow line in the liquid chilling circuit, with the heat exchanger further comprising a heat exchanger air inlet and a heat exchanger warmed air outlet, with the heat exchanger configured to transfer waste heat in the warmed liquid flow to an airflow entering the heat exchanger air inlet, an aircraft cargo compartment air duct in communication with an aircraft cargo compartment, said aircraft cargo compartment air duct further in communication with the heat exchanger warmed air outlet, and with the heat exchanger located upstream of the aircraft cargo compartment air duct.

Another present aspect is directed to a method for regulating temperature in an aircraft cargo compartment of an aircraft, with the method comprising directing an onboard liquid chilling circuit to an aircraft first region, with the liquid chilling circuit configured to provide cooling to the aircraft first region, with the onboard liquid chilling circuit further configured to direct captured heat from the aircraft first region away from the aircraft first region in a warmed liquid flow in the onboard liquid chilling circuit. The method further comprises directing the warmed liquid flow to a heat exchanger warmed liquid inlet of the heat exchanger, directing an airflow to a heat exchanger airflow inlet of the heat exchanger, generating a warmed airflow at the heat exchanger, and directing the warmed airflow from a heat exchanger warmed airflow outlet to an aircraft cargo compartment via an aircraft cargo compartment air duct, with the aircraft cargo compartment air duct in communication with the aircraft cargo compartment.

In another present aspect, a method further comprises actuating a warmed liquid valve positioned upstream of the heat exchanger to regulate entry of the warmed liquid flow from a warmed liquid flow line into the heat exchanger liquid inlet.

In another present aspect, a method further comprises actuating a warmed airflow valve positioned downstream of the heat exchanger and further positioned upstream of the aircraft cargo compartment to regulate entry of the warmed airflow from the heat exchanger warmed air outlet into the aircraft cargo compartment.

In another present aspect, a method further comprises sending an aircraft cargo compartment air temperature sensor signal from an aircraft cargo compartment air temperature sensor to a liquid valve controller, and ending a controller signal from the liquid valve controller to the warmed liquid valve to actuate the warmed liquid valve in response to the aircraft cargo compartment air temperature signal received by the liquid valve controller.

In another present aspect, a method further comprises sending an aircraft cargo compartment air temperature sensor signal from an aircraft cargo compartment air temperature sensor to a warmed airflow controller, and sending a controller signal from the warmed airflow controller to the warmed airflow valve to actuate the warmed airflow valve in response to the aircraft cargo compartment air temperature sensor signal received by the warmed airflow controller, with the method including delivering a heated airflow to the aircraft cargo compartment to raise and/or maintain an aircraft cargo compartment temperature to a selected aircraft cargo compartment air temperature.

In another present aspect, a method further comprises regulating an aircraft cargo compartment air temperature by directing waste heat absorbed from an aircraft first region to the aircraft cargo compartment via the onboard liquid chilling circuit, wherein the aircraft cargo compartment is not in communication with an electrical heater.

Another present aspect is directed to a method for regulating air temperature in an aircraft cargo compartment of an aircraft, with the method comprising installing into an aircraft, an aircraft cargo compartment temperature regulating system for directing waste heat from an aircraft liquid chilling circuit to an aircraft cargo compartment, with the aircraft cargo compartment temperature regulating system comprising an aircraft liquid chilling circuit for providing chilling to a first aircraft region to reduce an environmental temperature in the first aircraft region, said aircraft liquid chilling circuit configured to provide absorbed waste heat from the first aircraft region to form a warmed liquid flow in a warmed liquid flow line in the aircraft liquid chilling circuit, a heat exchanger located in line with the aircraft liquid chilling circuit, with the heat exchanger comprising a heat exchanger liquid inlet in communication with the warmed liquid flow line, with the heat exchanger further comprising a cooler liquid heat exchanger outlet in communication with a cooler liquid flow line in the liquid chilling circuit, with the heat exchanger further comprising a heat exchanger air inlet and a heat exchanger warmed air outlet, with the heat exchanger configured to transfer waste heat in the warmed liquid flow to an airflow entering the heat exchanger air inlet, an aircraft cargo compartment air duct in communication with an aircraft cargo compartment, said aircraft cargo compartment air duct further in communication with the heat exchanger warmed air outlet, and with the heat exchanger located upstream of the aircraft cargo compartment air duct.

The features, functions and advantages that have been discussed can be achieved independently in various aspects or may be combined in yet other aspects, further details of which can be seen with reference to the following description and the drawings.

### BRIEF DESCRIPTION OF THE DRAWINGS

Having thus described variations of the disclosure in general terms, reference will now be made to the accompanying drawings, which are not necessarily drawn to scale, and wherein:

FIG. 1 is an illustration of a vehicle in the form of an aircraft, according to present aspects;

FIG. 2 is a cross-sectional view of an aircraft of the type shown in FIG. 1, taken along line 2-2 as shown in FIG. 1;

FIG. 3A is a schematic diagram outlining a present aircraft cargo compartment air temperature regulating system, according to present aspects;

FIG. 3B is a schematic diagram outlining an enlarged view of a portion of the present aircraft cargo compartment air temperature regulating system also shown in FIG. 3A, and according to present aspects;

FIG. 3C is a schematic diagram outlining a present aircraft cargo compartment air temperature regulating system, according to present aspects;

FIG. 4 is an enlarged view of a liquid-to-air heat exchanger of the type incorporated into the present aircraft cargo compartment air temperature regulating system, according to present aspects;

FIG. 5 is a flowchart outlining a method (100), according to present aspects;

FIG. 6 is a flowchart outlining a method (200), according to present aspects;

FIG. 7 is a flowchart outlining a method (300), according to present aspects;

FIG. 8 is a flowchart outlining a method (400), according to present aspects;

FIG. 9 is a flowchart outlining a method (500), according to present aspects;

FIG. 10 is a flowchart outlining a method (600), according to present aspects;

FIG. 11 is a flowchart outlining a method (700), according to present aspects;

FIG. 12 is a flowchart outlining a method (800), according to present aspects; and

FIG. 13 is a flowchart outlining a method (900), according to present aspects.

### DETAILED DESCRIPTION

Present aspects are directed to the efficient redirection and re-purposing of waste heat absorbed into an aircraft liquid chilling circuit (to form a warmed fluid flow in the air chilling circuit), by directing the warmed fluid flow in the chilling circuit into a liquid-to-air heat exchanger located proximate to an aircraft cargo compartment to produce a warmed airflow (referred to equivalently herein as a heated airflow) that is directed into, and that is configured to provide selected heating into, an aircraft cargo compartment.

According to present aspects, the advantageous selective use, on demand, and in real time, of the thermal delta of an aircraft liquid chilling circuit to transfer absorbed waste heat from a chilled air circuit via a heat exchanger in close proximity to an aircraft cargo compartment can significantly decrease existing aircraft cargo compartment heating demands (e.g., power draw), and system complexity including, for example, decreasing overall aircraft power consumption, obviating or reducing the size of aircraft cargo compartment electric heaters, and reducing and/or eliminating the footprint, size characteristics, power consumption demands, maintenance, weight, etc., of such electrical heating units, eliminating the structural architecture and ducting related to establishing a flow of bleed engine air, etc. According to present aspects, the elimination of other heat generating assemblies that can include electrical heaters and/or the elimination of the weight of additional ducting and associated supports required to direct hot pneumatic bleed air from an aircraft engine can significantly increase overall aircraft operating efficiency through a decrease in fuel consumption, an increase in aircraft range, a decrease in operational cost, and other operational advantages.

The elimination of aircraft cargo compartment heaters, and the reduced overall aircraft power consumption demands (e.g., from batteries, APUs, etc.) can result in a significant reduction in the overall weight of an aircraft, resulting in significant decreases in operating cost, and a significant increase in efficiency that can result in the increase in sustainability and decrease in an environmental footprint of an aircraft.

Present aspects employ safe, modified, augmented heating through the application of waste heat redirection and waste heat usage and repurposing that can efficiently “heat” structural components and regions of an aircraft cargo compartment, on demand, (e.g., the direct heating of an aircraft cargo compartment floor) as well as the presently disclosed heating of an airflow directed into an aircraft cargo compartment air duct.

Present aspects are directed to the redirection, recapture, and repurposing of “waste heat” from an onboard aircraft chilled air circuit using the warmed thermal air chiller circuit liquid within and along an aircraft chiller circuit as a heating medium.

Present aspects are directed to the sensing of aircraft compartment thermal conditions, on demand, and in real time, as well as anticipating the thermal needs of an aircraft cargo compartment by transferring waste heat from a liquid contained within an aircraft liquid chilling circuit to form a warmed or heated airflow at and via a liquid-to-air heat exchanger, with the system controlled to initiate production of a warmed airflow that is configured to exit the heat exchanger, and with the produced warmed airflow directed into an aircraft cargo compartment. The warmed airflow is produced according to present aspects by incorporating one or more system controllers that can control valving of liquid flow and/or airflow in response to signals sent from thermal air sensors in conjunction with signals sent to the controller(s) by an aircraft data bus having programmed information relating to an aircraft flight condition (e.g., flight phase, altitude, ideal cargo compartment air temperature and deviation from ideal cargo compartment air temperature, etc.)

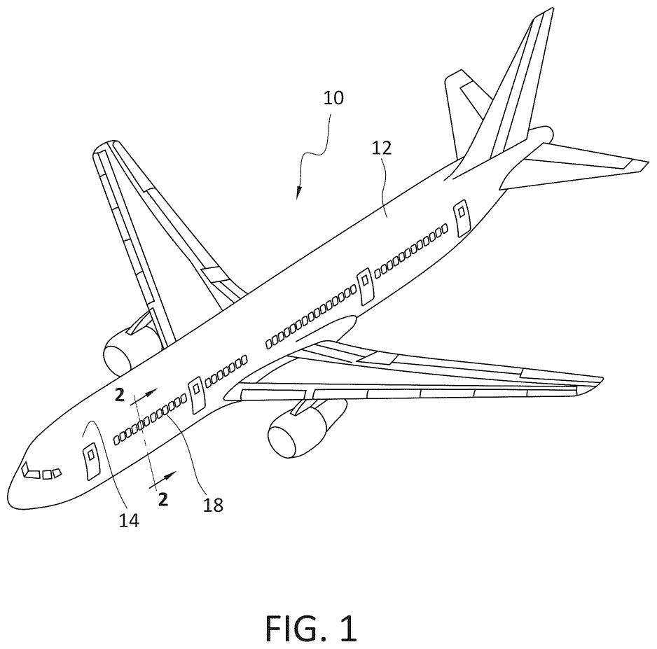

FIG. 1 is an illustration of an aircraft that comprises an aircraft cargo compartment. As shown in FIG. 1, aircraft 10 comprises a fuselage 12 with a passenger cabin 14, an aircraft cargo compartment 18 (that can be a forward cargo compartment, an aft cargo compartment, a mid cargo compartment, a bulk compartment, etc.) contained within the fuselage 12 and that can be located below a passenger cabin floor 17. In addition, presents aspects contemplate present systems and methods configured to regulate temperatures within an aircraft cargo compartment that may not be located beneath a passenger cabin floor; particularly in the case of freighter aircraft transporting cargo, and where the aircraft has no passenger compartment and the aircraft comprises a main deck cargo compartment, and cargo area.

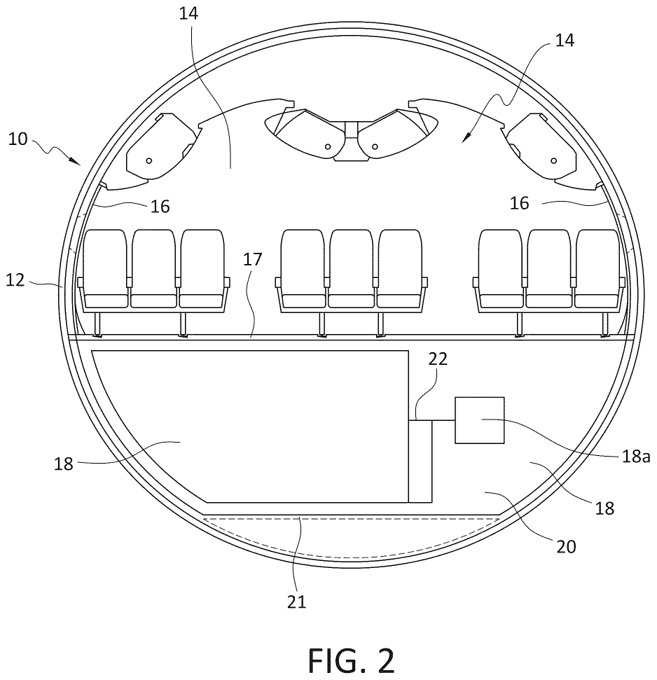

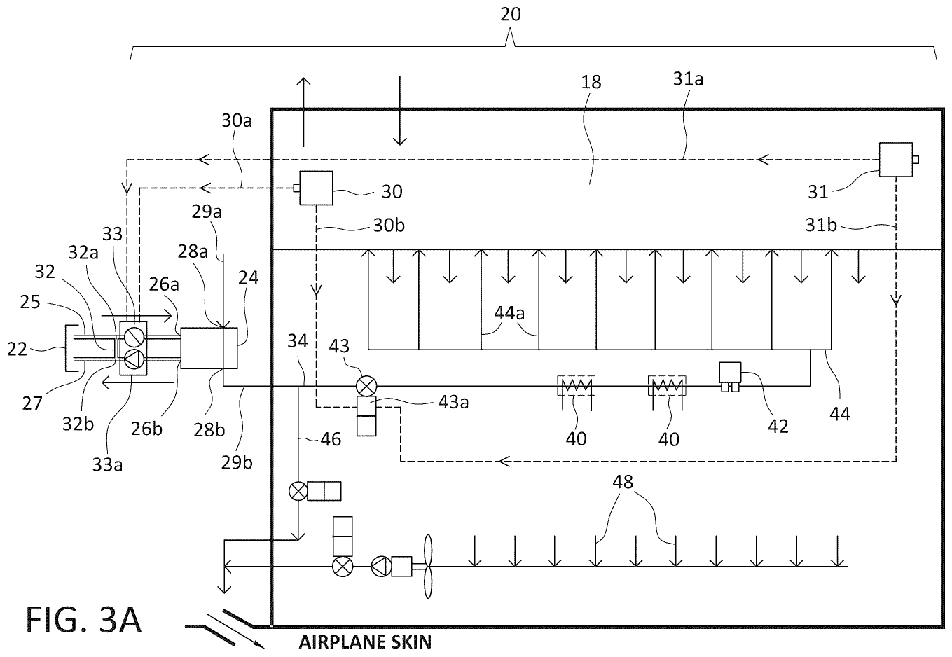

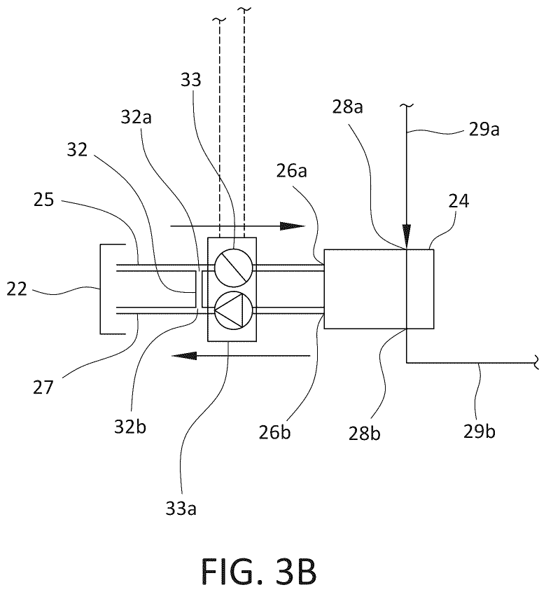

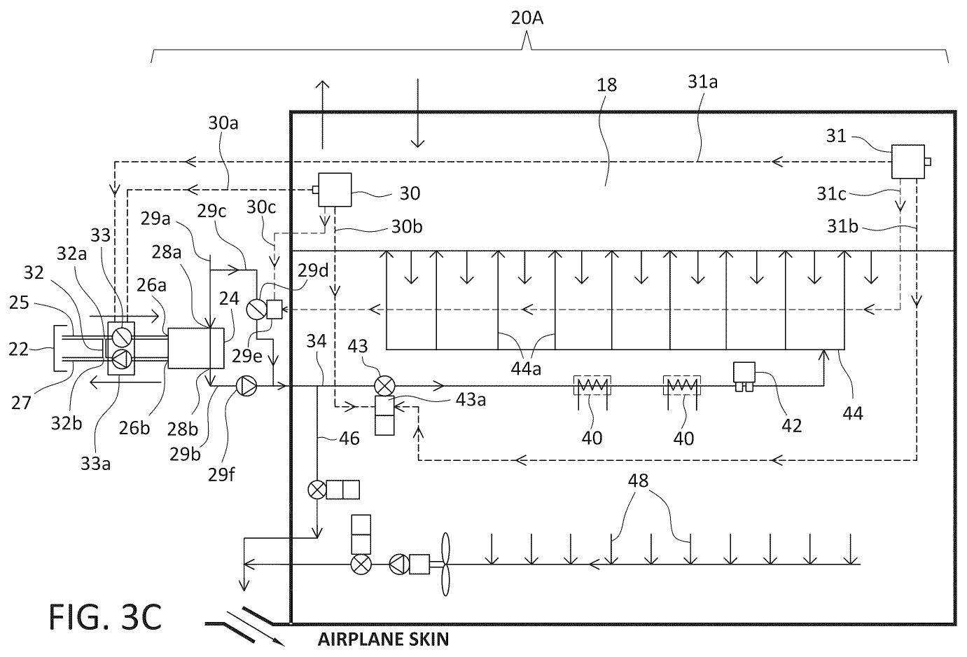

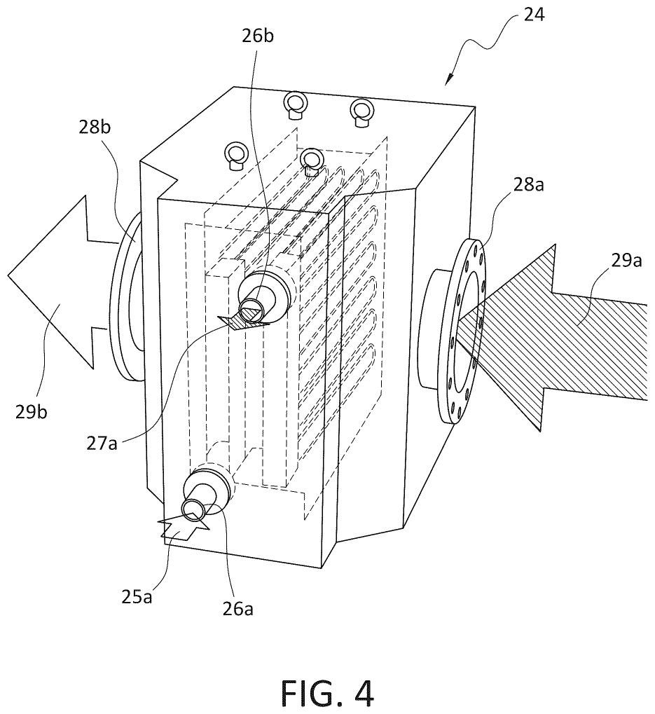

FIG. 2 is a representative cross-sectional view of the aircraft 10 of the type shown in FIG. 1 taken along line 2-2, with a view into aircraft 10 showing passenger cabin 14 bounded by a sidewall 16 and an aircraft passenger cabin floor 17, and further showing a view into a cargo compartment 18 bounded by sidewall 16, aircraft passenger cabin floor 17 and aircraft cargo compartment floor 21 and a heat generating equipment bay 18a that can be in communication with a liquid chilling circuit 22 (referred to equivalently herein as an onboard liquid chilling circuit; and with the chilling circuit comprising a liquid flow traversing through and contained within the liquid chilling circuit, and with the chilling circuit positioned and/or otherwise located within or “onboard” the aircraft as an aircraft system contained within the aircraft) configured to cool a heat generating equipment bay 18a (and other heat generating equipment including but not limited to, for example, electronics assemblies themselves, electrical boxes, galley refrigeration equipment, etc.), with the liquid chilling circuit 22 further configured to absorb heat from the heat generating equipment bay and direct a warmed liquid flow in the liquid chilling circuit (that has absorbed an amount of heat from the heat generating equipment) away from the heat generating equipment bay in the form of the warmed liquid flow containing absorbed “waste heat”. The regions shown “below deck” and the systems present in or proximate to the cargo compartment are shown in representative block diagram form only, with more detail provided in FIGS. 3A, 3B, 3C, 4 that are described herein.

According to present aspects, FIG. 3A is a schematic diagram of a present system 20 configured to regulate air temperature within an aircraft cargo compartment by producing and regulating a heated airflow that can be introduced into aircraft cargo air ducts that provide an airflow into the aircraft cargo compartment. As shown in FIG. 3A, system 20 comprises an aircraft cargo compartment placed in communication with a liquid chilling circuit 22 with the liquid chilling circuit 22 positioned upstream of heat exchanger 24 (referred to equivalently herein as a liquid-to-air heat exchanger), and with the aircraft cargo compartment further in communication with the heat exchanger, and with the heat exchanger positioned upstream of the aircraft cargo compartment and upstream of an aircraft cargo compartment air duct.

As further shown in FIG. 3A, liquid chilling circuit 22 comprises a warmed liquid flow line 25 that can deliver a fluid flow toward and into heat exchanger 24 via the heat exchanger liquid inlet 26a. The fluid flow in the liquid chilling circuit that is directed into the heat exchanger will have a warmed fluid flow temperature, as the fluid flow in the warmed liquid flow line 25 (although not shown in FIG. 3A) that is within the liquid chilling circuit 22 is understood to have encountered a region of the aircraft, and/or an assembly of the aircraft and/or an equipment compartment, etc. of the aircraft that requires “cooling” provided from the liquid chilling circuit. Such region, assembly, can be an equipment compartment that can be, for example, an electronics equipment bay or an electrical equipment bay (e.g., a high-power electronics bay, etc.), actual electronics themselves, and/or electrical boxes themselves (e.g., located within or outside of an “electronics bay” or “compartment”), a galley appliance and/or galley monument comprising one or more galley appliance(s), or other galley equipment, and/or air conditioning equipment, etc., that provides an air or liquid chilling/refrigeration function in the aircraft.

According to present aspects, when a cooler liquid flow line encounters a region to be “chilled”, heat is absorbed by the cooler liquid flow, and the temperature of the liquid “coolant” rises within the liquid flow line and the “waste heat” absorbed by the cooler liquid flow line (which them “warms” from the absorbed heat) is directed along the liquid chilling circuit until the “waste heat” can be offloaded from the liquid chilling circuit. According to present aspects, the waste heat absorbed into and by the liquid chilling circuit is efficiently and intentionally “offloaded” from the liquid chilling circuit by intentionally harvesting the waste heat at the liquid-to-air heat exchanger for the intentional purpose of using the waste heat to create a heated airflow at the heat exchanger. According to present aspects, the waste heat then repurposed as a heated airflow that is then directed to and that is otherwise provided to an aircraft cargo compartment air duct in real time and on demand to selectively warm and to otherwise selectively impact and selectively regulate air temperature within the aircraft cargo compartment; and with the chilling capacity of the liquid flow temperature of the liquid delivered away from the heat exchanger into the cooler liquid flow line returning to a cooler temperature in the liquid chilling circuit.

As shown in FIG. 3A, the warmed liquid flow line 25 transports a warmer temperature liquid as a warmer or warmed liquid flow (in the liquid chilling circuit 22) that comprises “waste heat”. The warmer liquid flow in the warmer liquid flow line 25 can reach a warmed liquid flow temperature ranging from about 80° F. to about 150° F.

According to the present system, and according to present aspects, a warmed liquid flow valve 33 is placed in line with the warmed liquid flowline 25 (referred to equivalently herein as a “warmer” liquid flow line). In operation, when a warmed liquid flow is selectively allowed to enter and pass through the warmed liquid flow valve in an open position, the warmed liquid flow in the warmed liquid flow line will proceed into the heat exchanger liquid inlet 26a of heat exchanger 24. Concurrently, an airflow 29a that is referred to equivalently herein as an environmental airflow (further referred to equivalently herein as an ambient airflow 29a) within the aircraft is directed into the heat exchanger air inlet 28a of heat exchanger 24.

The heat exchanger is constructed to facilitate a thermodynamic heat exchange such that heat from the warmer liquid flow (in the form of absorbed “waste heat”) is thermodynamically transferred to the airflow presented to the heat exchanger. The thermal exchange at the heat exchanger continues as the warmer liquid proceeds through the liquid conduits within the heat exchanger, with the outer surfaces of the liquid conduits contacting the airflow passing through the heat exchanger (shown in greater detail in FIG. 4). The thermal exchange continues within the heat exchanger 24 until a warmed airflow 29b (referred to equivalently herein as a heated airflow 29b) is directed out from the heat exchanger warmed air outlet 28b of heat exchanger 24, and a now cooler liquid flow (having transferred “waste heat” from the fluid flow into the airflow in the heat exchanger) exits the heat exchanger liquid outlet 26b of heat exchanger 24, and returns to, and is otherwise directed into, “cooler” liquid flow line 27 of liquid chilling circuit 22. According to present aspects, the warmed airflow produced within and exiting from heat exchanger 24 can reach temperature that is not lower than about 55° F. In another present example, the warmed airflow produced within and exiting from heat exchanger 24 can reach a temperature ranging from about 70° F. to about 140° F.

As further shown in FIG. 3A, according to present aspects, in system 20, heat exchanger warmed air outlet 28b is placed in direct communication with aircraft cargo compartment air duct 34, with the warmed airflow 29b exiting heat exchanger 24 directed downstream of the heat exchanger and into aircraft compartment air duct 34 (equivalently referred to herein as air duct 34). The air duct 34 can be in further communication with a warmed airflow (e.g., “splitting”) manifold 44 (referred to equivalently herein as “heated” airflow manifold) that can direct multiple warmed airflows from the manifold 44 into the aircraft cargo compartment 18 via a one or more aircraft cargo compartment warmed air inlet lines 44a.

According to a present aspect, the “warming” or “heating” of the airflow to form the warmed airflow is exclusively conducted via (e.g., the airflow is exclusively warmed by, and the airflow incurs an airflow temperature increase that is exclusively the result of) the thermal exchange occurring at the heat exchanger (referred to equivalently herein as a liquid-to-air heat exchanger), with an amount of heat in the warmed liquid flow transferred to the airflow entering the heat exchanger to form the now warmed airflow exiting the heat exchanger. That is, according to a present example, the warmed liquid flow in the liquid chilling circuit directed to the heat exchanger is substantially exclusively responsible for heating (e.g., increasing) or maintaining an air temperature within the aircraft cargo compartment.

According to present aspects, and as shown in FIG. 3A, aircraft cargo compartment 18 comprises one or more aircraft cargo compartment air temperature sensor(s) 30, 31 (referred to equivalently herein as temperature sensor(s)) configured to monitor, record, report and otherwise “sense” the air temperature within the aircraft cargo compartment. In addition, air duct 34 can comprise an air duct temperature sensor 42 placed in communication with air duct 34.

In operation, aircraft cargo compartment air temperature sensor 30, is configured to send air temperature signal 30a to liquid valve controller 33a. Aircraft cargo compartment air temperature sensor 30, is further configured to send air temperature signal 30b to warmed air valve controller 43a. In similar fashion, as shown in FIG. 3A, aircraft cargo compartment air temperature sensor 31, is configured to send air temperature signal 31a to liquid valve controller 33a. Aircraft cargo compartment air temperature sensor 31, is further configured to send air temperature signal 31b to warmed air valve controller 43a.

While the controllers are shown as discrete components, the controllers can be a computing device incorporated into the valve assemblies to accomplish receipt of the signals from the temperature sensors and to govern directly or indirectly the actuation of the valves to a selected position in response to and in receipt of the temperature sensor signals. In addition, (though not shown in FIG. 3A) the controllers can be in communication with and otherwise configured to receive signals from an aircraft data bus and can otherwise be configured to receive signals from an input station located onboard and/or located remotely from the aircraft and the controllers can otherwise be programmed to operate and control the valves in response to input or programming of a pilot, a cargo master, a maintenance crew, etc., as well as operate automatically in response to the air temperature sensors.

In some present examples, as mentioned herein, the controller is a stand-alone component. In some examples, the controller is incorporated into one or more other computing devices on the aircraft such as but not limited to a valve-controlling controller. The controller can include one or more of each of a number of components such as, for example, processing circuitry (e.g., processor unit) connected to a memory circuitry (e.g., storage device). The processing circuitry may be composed of one or more processors alone or in combination with one or more memories. The processing circuitry is generally computer hardware that is capable of processing information such as, for example, data, computer programs and/or other suitable electronic information. The processing circuitry is composed of a collection of electronic circuits some of which may be packaged as an integrated circuit or multiple interconnected integrated circuits (an integrated circuit at times more commonly referred to as a “chip”). The processing circuitry may be configured to execute computer programs with programming instructions which may be stored onboard the processing circuitry or otherwise stored in the memory circuitry (of the same or another device).

The processing circuitry may be a number of processors, a multi-core processor or some other type of processor, depending on the particular implementation. Further, the processing circuitry may be implemented using a number of heterogeneous processor systems in which a main processor is present with one or more secondary processors on a single chip. As another illustrative example, the processing circuitry may be a symmetric multi-processor system containing multiple processors of the same type. In yet another example, the processing circuitry may be embodied as or otherwise include one or more ASICs, FPGAs or the like. Although the processing circuitry may be capable of executing a computer program to perform one or more functions, the processing circuitry of various examples may be capable of performing one or more functions without the aid of a computer program. In either instance, the processing circuitry may be appropriately programmed to perform functions or operations according to example implementations of the present disclosure.

The memory circuitry is generally computer hardware that is capable of storing information such as, for example, data, computer programs (e.g., computer-readable program code) and/or other suitable information either on a temporary basis and/or a permanent basis. The memory circuitry may include volatile and/or non-volatile memory and may be fixed or removable. Examples of suitable memory circuitry include random access memory (RAM), read-only memory (ROM), a hard drive, a flash memory, a thumb drive, a removable computer diskette, an optical disk, a magnetic tape or some combination of the above. Optical disks may include compact disk-read only memory (CD-ROM), compact disk-read/write (CD-R/W), DVD or the like. In various instances, the memory circuitry may be referred to as a computer-readable storage medium. The computer-readable storage medium is a non-transitory device capable of storing information and is distinguishable from computer-readable transmission media such as electronic transitory signals capable of carrying information from one location to another. Computer-readable medium as described herein may generally refer to a computer-readable storage medium or computer-readable transmission medium.

Present controllers can also include communications circuitry configured to transmit and/or receive information, such as to and/or from other systems on an aircraft, the flight deck, and a remote node that is monitoring from the ground the status of the aircraft 10. The communications circuitry may be configured to transmit and/or receive information by physical (wired) and/or wireless communications links. Examples of suitable communication interfaces include a network interface controller (NIC), wireless NIC (WNIC), or the like. The communications circuitry may have one or more transmitters and/or receivers. In some examples, a user interface is included to enable input from the flight personnel and associated output. The user interface can include one or more input devices such as but not limited to a keypad, touchpad, roller ball, and joystick. The user interface also includes one or more displays for displaying information regarding the fuel jettison.

As will be appreciated by those of ordinary skill in the art without undue experimentation, program code instructions may be loaded onto a computing device or other programmable apparatus from a computer-readable storage medium to produce a particular machine, such that the particular machine becomes a means for implementing the functions specified herein. These program code instructions may also be stored in a computer-readable storage medium that can direct a computer, a processing circuitry or other programmable apparatus to function in a particular manner to thereby generate a particular machine or particular article of manufacture. The program code instructions may be retrieved from a computer-readable storage medium and loaded into a computer, processing circuitry or other programmable apparatus to configure the computing device, processing circuitry or other programmable apparatus to execute operations to be performed on or by the computer, processing circuitry or other programmable apparatus.

In system operation and according to present aspects, warmed liquid flow controller 33a is configured to control the operation of warmed liquid flow valve 33 between a selected open flow position and a selected closed valve position, and to include selected positions therebetween to include selected partially opened valve positions. The warmed airflow controller 43a is configured to control the operation of warmed airflow valve 43 between a selected open flow position and a selected closed valve position, and to include selected positions therebetween to include selected partially opened valve positions. The present systems and methods can be initiated, maintained, and terminated in response to air temperature sensor signals received by the controllers, and/or in response to programming relative to flight conditions to include, for example, flight phase, altitude, cargo compartment selected target temperature, etc.

Returning to FIG. 3A, in one present example, when a need exists to warm and/or to maintain a cargo compartment air temperature to, or at, a selected temperature as established by the present system, the warmed liquid valve 33 is actuated in real time and on demand to an open or partially opened position to direct and admit warmed liquid from the warm liquid flow line of the liquid chilling circuit to an operational heat exchanger (with an airflow also directed to the heat exchanger), and warmed air valve 43 is actuated to an open or partially opened position to then direct and admit the warmed airflow produced at the heat exchanger to the cargo compartment via the aircraft compartment air duct.

In another present example, when the aircraft cargo compartment comprises a suitable selected air temperature that does not require additional heating, the warmed liquid valve 33 can be actuated to an open or partially opened position to direct and admit warmed liquid to the operational heat exchanger with an airflow directed to the heat exchanger, and the heat exchanger is operational to produce a warmed airflow. However, in this example, warmed air valve 43 is not actuated to an open position to admit a warmed airflow to the aircraft cargo compartment air duct (e.g., the warmed airflow valve remains or is returned to a closed position). In this example, the warmed airflow produced by the heat exchanger can be redirected via warmed airflow line 46 to another warming use in the aircraft that can include the aircraft compartment floor, and/or other aircraft locations that can be heated by the waste heat in the liquid chilling circuit including, for example, an aircraft cargo compartment floor.

In another present example, when heat is not needed in the aircraft cargo compartment (e.g., during hot ambient conditions outside the aircraft; for example, on a runway in a hot climate, etc.), both the warm liquid valve 33 and the warmed airflow valve 43 can be controlled to remain in or return to a closed position, and the warmed liquid flow does not enter the present system heat exchanger and instead circulates only within the liquid chilling circuit, and no warmed air is produced at the heat exchanger. In this configuration, the warmed liquid flow in the warmed liquid flow line 25 cannot gain entry to the heat exchanger 24 and instead the warmed liquid flow proceeds along liquid flow line 32 with appropriate valving positioned to allow and direct flow into liquid flow line 32 via operational flow line valves 32a, 32b positioned at locations, as also shown in FIG. 3B.

In system operation, and according to present aspects, warmed liquid flow controller 33a is configured to control the operation of warmed liquid flow valve 33 positioned between a selected open flow position and a selected closed valve position, and to include positions therebetween to include selected partially opened valve positions, and the warmed airflow controller 43a is configured to control the operation of warmed airflow valve 43 between a selected open flow position and a selected closed valve position, and to include positions therebetween to include selected partially opened valve positions.

The portion of the present system 20 comprising the liquid chilling circuit 22 and the heat exchanger 24 is shown in an enlarged view in FIG. 3B. As shown in FIG. 3B, system 20 comprises a liquid chilling circuit 22 positioned upstream of heat exchanger 24 (referred to equivalently herein as a liquid-to-air heat exchanger). As further shown in FIG. 3B, liquid chilling circuit 22 comprises a warmed liquid flow line 25 that can deliver a fluid flow toward and into heat exchanger 24 via the heat exchanger liquid inlet 26a. The fluid flow in the liquid chilling circuit that is directed into the heat exchanger will have a warmed fluid flow temperature as explained herein, as the fluid flow in the warmed liquid flow line 25 (although not shown in FIG. 3B) within the liquid chilling circuit 22 is understood to have encountered a region of the aircraft, and/or an assembly of the aircraft and/or an equipment compartment of the aircraft and/or equipment of the aircraft that required “cooling” provided from the liquid chilling circuit.

As shown in FIG. 3B, the warmed liquid flow line 25 transports a warmer temperature liquid (within the liquid chilling circuit 22) that comprises “waste heat”. The warmer liquid flow in the warmer liquid flow line 25 can reach a warmed liquid flow temperature ranging from about 80° F. to about 150° F. According to the present system, and according to present aspects, a warmed liquid flow valve 33 is placed in line with the warmed liquid flow line 25 (referred to equivalently herein as a “warmer” liquid flow line). In operation, when a warmed liquid flow is selectively allowed to enter and pass through warmed liquid flow valve in an open position, the warmed liquid flow in the warmed liquid flow line will proceed into the heat exchanger liquid inlet 26a of heat exchanger 24. Concurrently, an airflow 29a that is referred to equivalently herein as an environmental airflow and/or a localized or “ambient” airflow 29a within the aircraft is directed into the heat exchanger air inlet 28a of heat exchanger 24. The heat exchanger is constructed to facilitate a thermodynamic heat exchange such that heat from the warmer liquid flow (in the form of absorbed “waste heat”) is thermodynamically transferred to the airflow presented to the heat exchanger. The thermal exchange at the heat exchanger continues as the warmer liquid proceeds through the liquid conduits within the heat exchanger, with the outer surfaces of the liquid conduits contacting the airflow passing through the heat exchanger, and as is further shown in FIG. 4.

The thermal exchange continues within the heat exchanger 24 until a warmed airflow 29b is directed out from the heat exchanger warmed air outlet 28b of heat exchanger 24, and a now cooler liquid flow (having transferred “waste heat” from the fluid flow into the airflow in the heat exchanger) exits the heat exchanger liquid outlet 26b of heat exchanger 24, and returns and is otherwise directed into “cooler” liquid flow line 27 of liquid chilling circuit 22. According to one present example, the warmed airflow produced within and exiting from heat exchanger 24 can reach a temperature ranging from about 70° F. to about 140° F.

Perhaps more visible in FIG. 3B, and according to a present example, when warmed liquid control valve 33 is moved to a “closed” position that inhibits a warmed liquid flow from proceeding to heat exchanger 24 (e.g., when warming of the air temperature in a cargo compartment is not needed, and the heat exchanger is not operational), the liquid flow in the liquid chilling circuit can proceed past a liquid flow line valve 32a in an open position and be permitted to enter a liquid flow line 32 (referred to equivalently herein as a liquid flow line “bypass”) and proceed past an optional additional liquid flow line valve 32b with the fluid flow entering cooler liquid flow line 27 of the liquid chilling circuit and not come into contact with heat exchanger 24 (albeit at a warmer temperature that would be the case if the warmer liquid flow entered and departed the heat exchanger, as described herein). That is, although valves 32a, 32b are not specifically shown in FIG. 3B, “32a”, “32b” can designate the location that valves could occupy. When the present system 20 operates to produce a heated airflow from the heat exchanger, valves 32a, 32b could be positioned in a closed position (e.g., maintaining a closed valve position restricting heated liquid flow into liquid flow line 32a when the cargo compartment heating demand requires a maximum heated liquid flow into heat exchanger 24).

An additional present system architecture is shown in FIG. 3C; showing the addition of a “circuit” configured to maintain passage of a maintained untreated (e.g., non-heated, or unheated) airflow to the cargo compartment, even when the present heating systems are not operational and/or when the heated airflow system valve is moved to an “off” position to block delivery of a heated airflow to the cargo compartment. In this present example, as shown in FIG. 3C, present systems and methods ensure the delivery of an airflow that may be an unheated airflow to the cargo compartment that can be maintained in situations, flight phases, etc., where an airflow and air circulation is desired into a cargo compartment, even when a heated airflow is not being delivered to a cargo compartment. That is, in recognition of situations where some airflow is desired to a cargo compartment, according to present aspects, when system 20 may not be operational (e.g., no additional heating required for a cargo compartment), if valve 43 is fully closed, general airflow to the cargo compartment may be restricted.

As shown in FIG. 3C, and according to present aspects, an airflow bypass line and airflow bypass valve can be included to run “in parallel” with the airflow lines delivered to and from the heat exchanger, such that, when the heat exchanger is not operational, and/or no heated airflow function is selected, the airflow bypass line controlled by the airflow bypass valve is configured to permit an airflow to the aircraft cargo compartment via the aircraft cargo compartment air duct.

In this configuration, airflow bypass valve 29d can be configured to control delivery of and facilitate passage of a heated airflow (e.g., from the heat exchanger to the aircraft cargo compartment via the aircraft compartment air duct) and airflow bypass valve 29d can also control, regulate, etc., a bypass airflow around the heat exchanger (that is not be heated), and/or to allow mixing of non-heated and heated air that can then be introduced to the aircraft cargo compartment.

Therefore, in one present example, warmed airflow valve 43 can be configured to completely shut off airflow to the aircraft cargo compartment when heated airflow line is only “in line” with a heated airflow line from the heat exchanger (as shown in FIG. 3A). In another present example, as shown in FIG. 3C, warmed airflow valve 43 is in communication with both the heated airflow line from the exchanger, and warmed airflow valve 43 is also in communication with an airflow bypass line and/or warmed airflow valve 43 is configured to control and achieve an airflow having heated, unheated, and selectively partially heated airflow having a selected temperature into the aircraft cabin compartment.

As shown in FIG. 3C, an aircraft cargo compartment temperature regulating system 20A is shown comprising the enumerated elements shown at least in FIG. 3A with the enumerated elements performing equivalently as described herein, and with system 20A additionally comprising an airflow bypass line 29c in communication with airflow 29a and located upstream of the heat exchanger 24. As shown in FIG. 3C, airflow bypass line 29c is configured to deliver a bypass airflow to airflow bypass valve 29d regulated by airflow bypass valve controller 29e.

As further shown in FIG. 3C, when the heat exchanger is not engaged, and/or when the airflow bypass valve is otherwise engaged to an open position admitting a bypass airflow into airflow bypass valve 29d, airflow check valve 29f in communication with airflow bypass line 29c can be moved to an open position to direct bypassed airflow in the airflow bypass line 29c into aircraft cargo compartment airduct 34. In one present example, airflow check valve 29f can function with no associated controller, with airflow check valve 29f functioning to prevent backflow of bypass airflow back into the heat exchanger (e.g., via the heat exchanger outlet). In one present example, the desired or selected downstream air temperature within the aircraft cargo compartment air duct can be achieved, maintained, etc., by modulating a correct ratio of heat exchanger warmed airflow-to-bypass airflow at airflow bypass valve 29d (and according to one example, with no airflow modulation required at airflow check valve 29f). FIG. 3C further shows airflow bypass valve controller 29e in communication with air temperature sensors 30, 31, and FIG. 3C further shows with airflow bypass valve controller 29e configured to receive air temperature sensor signals 30c, 31c from air temperature sensors 30, 31, respectively.

FIG. 4 is a representative partially exposed view of a heat exchanger 24 of the type that can be incorporated into the circuits and systems described herein, and according to present aspects, with the understanding that pathway and inlet and outlet locations can vary to accommodate selected positioning of circuit lines for selected systems, etc. As shown in FIG. 4, and according to present aspects, the warmed (“warmer”) liquid flow 25a in the warmed liquid flow line 25 in the liquid chilling circuit 22 is introduced at heat exchanger liquid inlet 26a and otherwise enters into and passes through the heat exchanger 24 and exits the heat exchanger from the heat exchanger liquid outlet 26b at a slightly “cooler” temperature as a cooler liquid flow 27a in cooler liquid flow line 27; as the waste heat in the warmed liquid flow is thermodynamically transferred in the heat exchanger to an airflow in the heat exchanger that contacts liquid conduits within the heat exchanger. As shown in FIG. 4, the entry of the warmed liquid flow 25a into the heat exchanger is represented by the small unshaded arrow entering heat exchanger warmed liquid flow inlet 26a, and the now cooler liquid flow 27a exits from the heat exchanger at the heat exchanger (cooler) liquid outlet 26b represented by the small, shaded arrow.

An airflow 29a comprising environmental air (e.g., as used herein, the term “ambient” can refer to “environment” or “localized” air within the aircraft), enters heat exchanger 24 at heat exchanger air inlet 28a, proceed through the heat exchanger 24, and exits the heat exchanger via the heat exchanger warmed air outlet 28b, with the warmed airflow 29b exiting the heat exchanger having been “warmed” or “heated” to a significantly higher temperature that the airflow temperature of the airflow 29a entering the heat exchanger 24. As shown in FIG. 4, the airflow 29a entry into the heat exchanger is represented by the large, shaded arrow entering heat exchanger air inlet 28a, and the “warmed” airflow 29b exiting from the heat exchanger at the heat exchanger warmed air outlet 28b is represented by the large, unshaded arrow.

As stated herein, when a selected cargo compartment air temperature, for example, during flight, falls below a selected temperature (e.g., 50° F., etc.), the heating systems of the present disclosure can be activated in real time and on demand to provide a heated airflow to an aircraft cargo compartment without the present systems obviating the need for other air heating equipment that has typically been present in aircraft cargo compartment heating components and/or systems (e.g., obviating the typical use of electrical heaters, the direction of aircraft bleed air, etc.). Presently obviated heating components, in the form of obviated and or eliminated electrical heaters 40 are shown in FIGS. 3A, 3C, as “dotted line” components to illustrate where such components were previously typically located within a cargo compartment air duct with such electrical heaters 40 intentionally not a part of the present systems 20, 20A.

Present systems therefore provide a temperature regulating system for heating an aircraft cargo compartment that efficiently scavenges heat from other aircraft systems that, for example, release heat and that require cooling, and implement liquid chilling circuits of the type that may be in use to cool or otherwise condition and decrease temperatures in aircraft compartments, regions, areas, cabins, monuments, electronic equipment, electrical equipment assemblies, etc., including, for example, high-powered electrical equipment compartments, galley compartments, passenger compartments, etc. The scavenged heat is then redirected and otherwise repurposed as redirected “waste heat” (that would otherwise be lost or unused in the aircraft) to heat an aircraft cargo compartment, becoming the predominant and/or exclusive and/or substantially exclusive means for heating an aircraft cargo compartment, with the present systems and methods obviating the need for electrical heaters and/or that obviates the need for ducted assemblies for directing hot pneumatic bleed air from aircraft engines typically used to heat an aircraft cargo compartment.

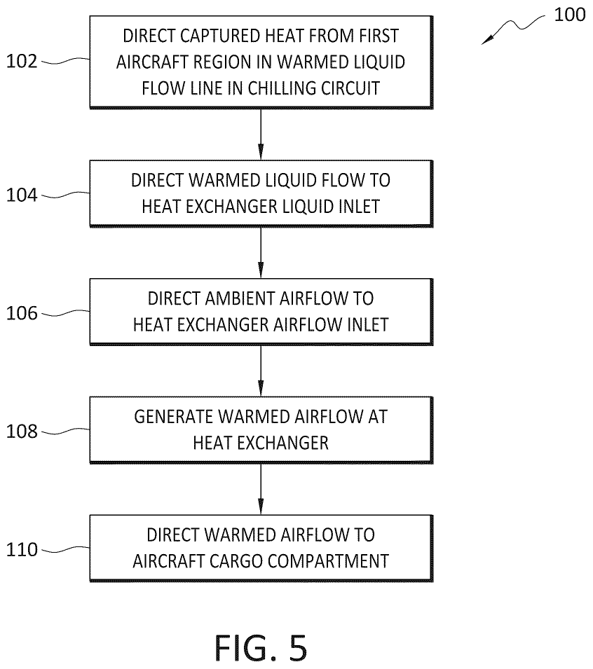

FIGS. 5, 6, 7, 8 ,9, 10, 11, 12, and 13 are flowcharts outlining present methods according to present aspects. The methods described herein can employ the systems shown in FIGS. 1, 2, 3A, 3B, 3C and 4, and as described herein.

As shown in FIG. 5, a present method 100 for regulating temperature in an aircraft cargo compartment of an aircraft comprises directing 102 an onboard liquid chilling circuit to an aircraft first region, with the liquid chilling circuit configured to provide cooling to the aircraft first region, with the onboard liquid chilling circuit further configured to direct captured heat away from the aircraft first region in a warmed liquid flow in a warmed liquid flow line in the onboard liquid chilling circuit, directing 104 the warmed liquid flow to a liquid-to-air heat exchanger liquid inlet of a liquid-to-air heat exchanger, directing 106 an ambient airflow to a heat exchanger airflow inlet of the liquid-to-air heat exchanger, generating 108 a warmed airflow at the liquid-to-air heat exchanger; and directing 110 the warmed airflow from the liquid-to-air heat exchanger warmed airflow outlet to an aircraft cargo compartment via an aircraft cargo compartment air duct in communication with the aircraft cargo compartment.

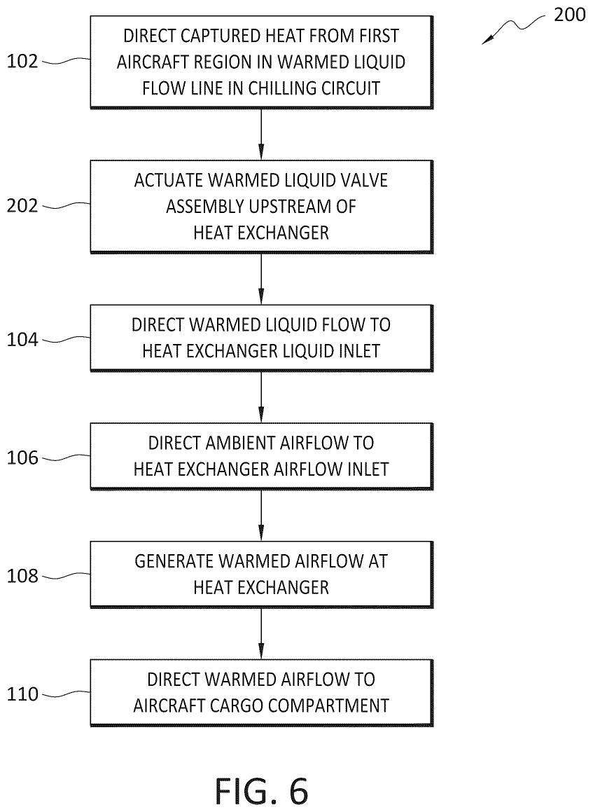

FIG. 6 outlines a method 200 that incorporates the features of method 100 (shown in FIG. 5) and further comprises actuating 202 with an actuator a warmed liquid valve assembly positioned upstream of the liquid-to-air heat exchanger to regulate entry of the warmed liquid flow from the warmed liquid flow line into the liquid-to-air heat exchanger liquid inlet.

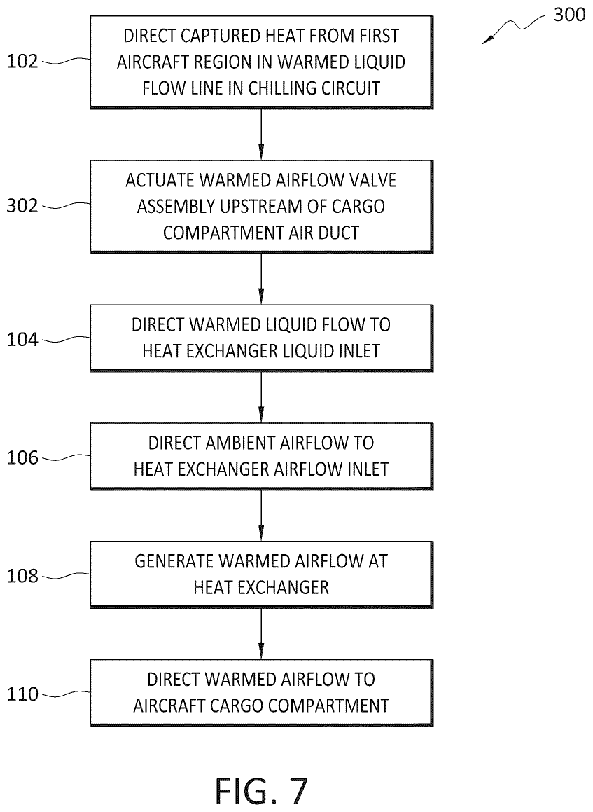

FIG. 7 outlines a method 300 that incorporates the features of method 100 (shown in FIG. 5) and further comprises actuating 302 with an actuator a warmed airflow valve assembly positioned upstream of the aircraft cargo compartment air duct to regulate entry of the warmed airflow from a warmed airflow line into the aircraft cargo compartment air duct (or in parallel with the heat exchanger when the warmed airflow valve also regulates unheated airflow entry to the cargo compartment), with the warmed airflow line in communication with the liquid-to-air heat exchanger warmed airflow outlet, said warmed airflow line further in communication with the aircraft cargo compartment air duct.

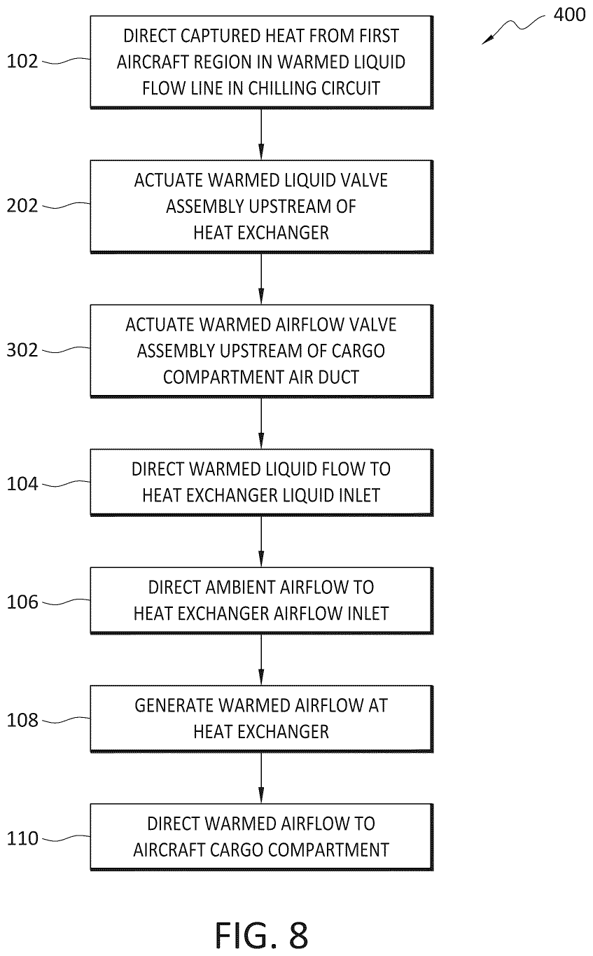

FIG. 8 outlines a present method 400 that incorporates the features of method 200 (shown in FIG. 6) and further comprises actuating 302 with an actuator a warmed airflow valve assembly positioned upstream of the aircraft cargo compartment air duct to regulate entry of the warmed airflow from a warmed airflow line into the aircraft cargo compartment air duct, with the warmed airflow line in communication with the liquid-to-air heat exchanger warmed airflow outlet, said warmed airflow line further in communication with the aircraft cargo compartment air duct.

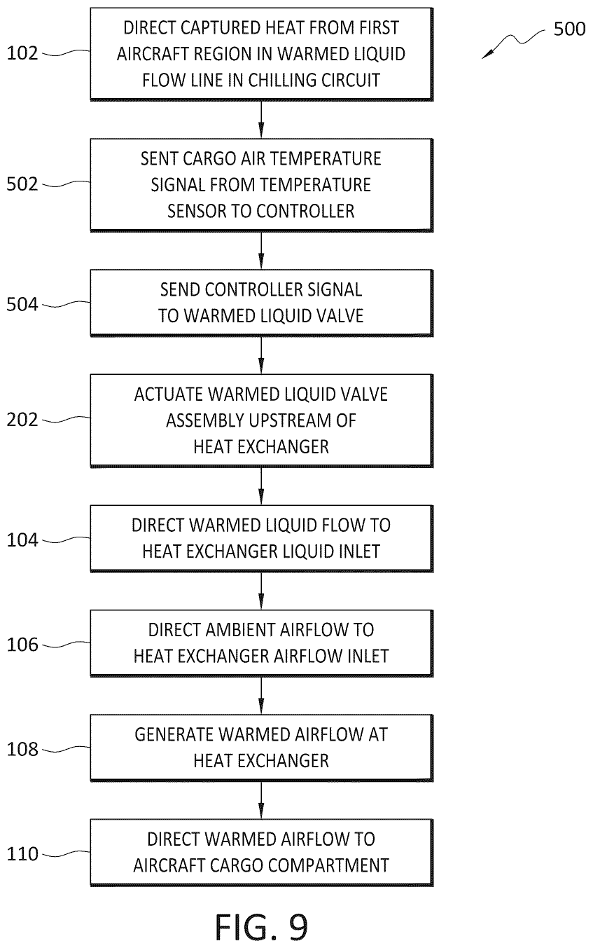

FIG. 9 outlines a present method 500 that incorporates the features of method 200 (shown in FIG. 6), and further comprises sending 502 an aircraft cargo compartment air temperature sensor signal from an aircraft cargo compartment air temperature sensor to a controller and sending 504 a controller signal from the warmed airflow valve controller to the warmed liquid valve assembly to actuate the warmed liquid valve assembly in response to the aircraft cargo compartment air temperature signal received by the controller.

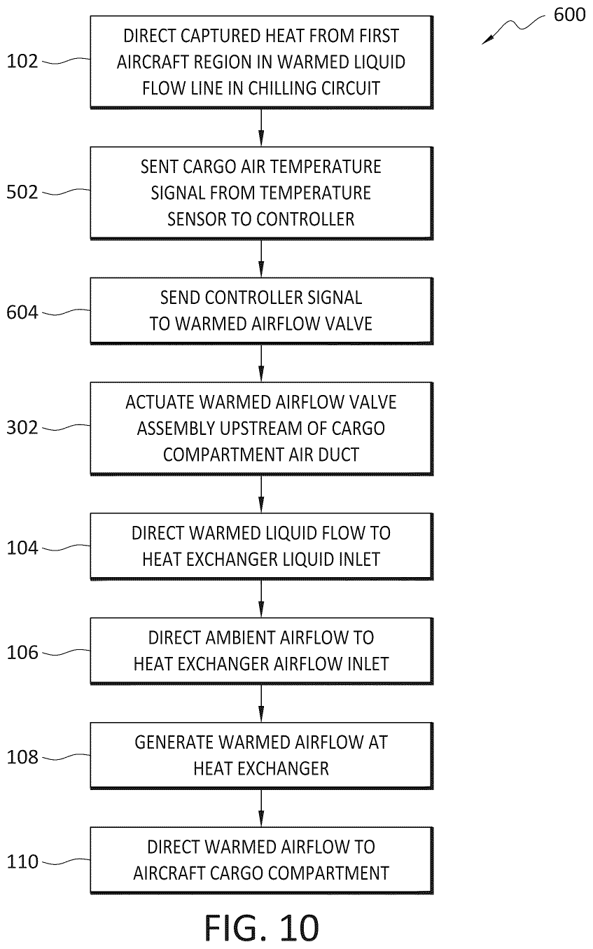

FIG. 10 outlines a present method 600 that incorporates the features of method 300 (shown in FIG. 7) and further comprises sending 502 an aircraft cargo compartment air temperature sensor signal from an aircraft cargo compartment air temperature sensor to a warmed airflow controller, and sending 604 a controller signal from the warmed airflow controller to the warmed airflow valve assembly to actuate the warmed airflow valve assembly in response to the aircraft cargo compartment air temperature sensor signal received by the controller.

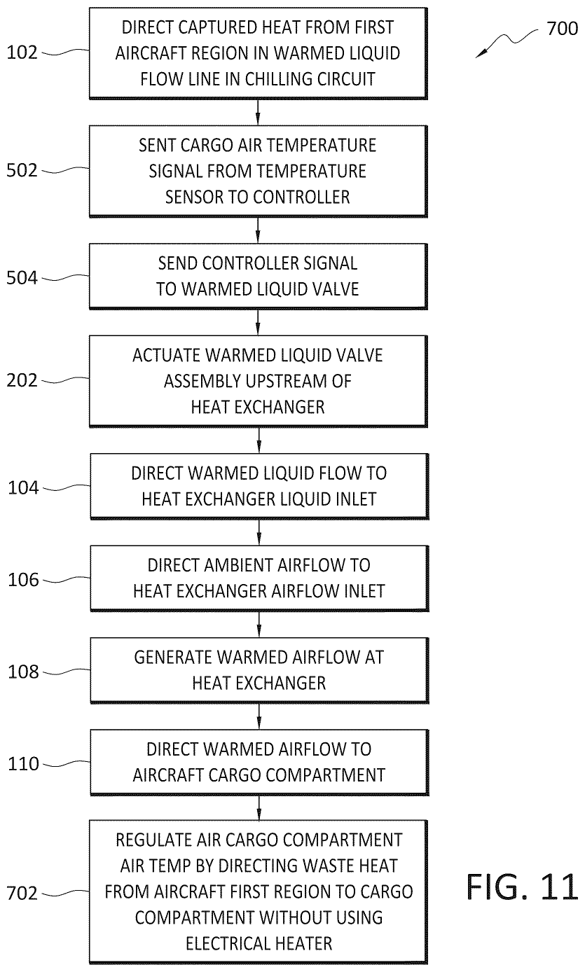

FIG. 11 outlines a present method 700 that incorporates the features of method 500 (shown in in FIG. 9) and further comprises regulating 702 an aircraft cargo compartment air temperature by directing waste heat absorbed from an aircraft first region to the aircraft cargo compartment air duct via the onboard liquid chilling circuit, wherein the aircraft cargo compartment is not in communication with an electrical heater or other heating system or heating apparatus including hot pneumatic heating from an aircraft engine (e.g., a directed bleed airflow, etc.).

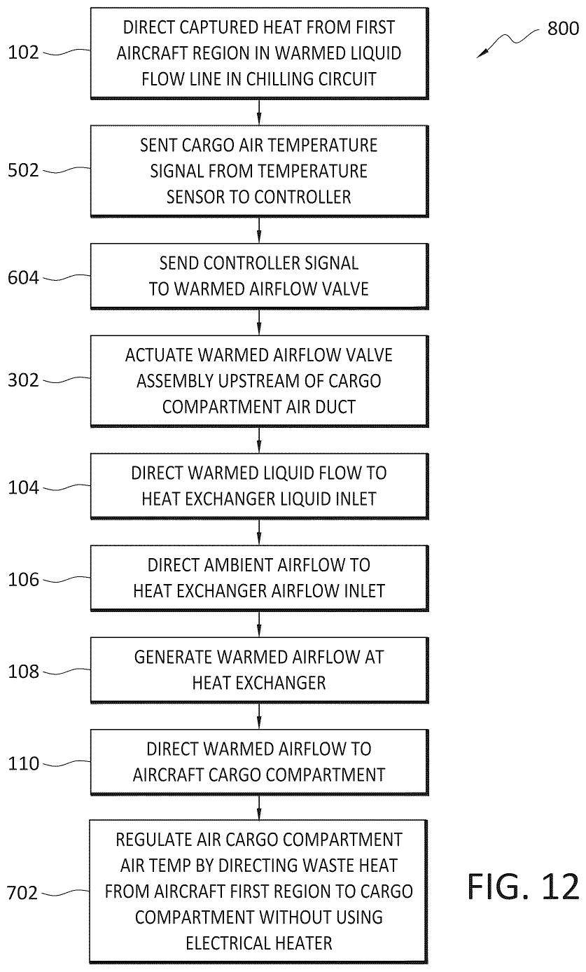

FIG. 12 outlines a present method 800 that incorporates the features of method 600 (shown in FIG. 10), and further comprises regulating 702 an aircraft cargo compartment air temperature by directing waste heat absorbed from an aircraft first region to the aircraft cargo compartment air duct via the onboard liquid chilling circuit, wherein the aircraft cargo compartment is not in communication with an electrical heater or other heating system or heating apparatus including hot pneumatic heating from an aircraft engine (e.g., a directed bleed airflow, etc.).

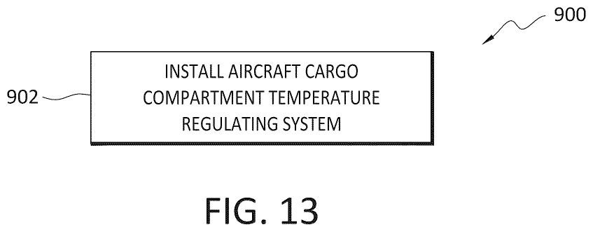

FIG. 13 outlines a present method 900 for regulating air temperature in an aircraft cargo compartment of an aircraft, with the method comprising installing 902 into an aircraft, an aircraft cargo compartment temperature regulating systems 20, 20A (referred to equivalently herein as an aircraft cargo compartment heating system) for directing waste heat from an aircraft liquid chilling circuit 22 to an aircraft cargo compartment 18, with the aircraft cargo compartment temperature regulating system 20 comprising an aircraft liquid chilling circuit 22 for providing chilling to a first aircraft region to reduce an ambient temperature in the first aircraft region, said aircraft liquid chilling circuit configured to provide absorbed waste heat from the first aircraft region to form a warmed liquid flow in a warmed liquid flow line 32 in the aircraft liquid chilling circuit 22, a liquid-to-air heat exchanger 24 located in line with the aircraft liquid chilling circuit 22, with the liquid-to-air heat exchanger located upstream of an aircraft cargo compartment air duct 34, with the aircraft cargo compartment air duct air duct in communication with the aircraft cargo compartment 18, with the heat exchanger comprising a heat exchanger liquid inlet 26a in communication with the warmed liquid flow line 25, with the heat exchanger 24 further comprising a cooler liquid heat exchanger outlet 26b in communication with a cooler liquid flow line 27 in the liquid chilling circuit 22, said heat exchanger 24 further in communication with an ambient air inlet 28a and a heated air outlet 28b, with the heated air outlet 28b in direct communication with an aircraft cargo compartment air duct 34.

The systems, apparatuses, and methods described herein can further incorporate system controllers, sensors, detectors, thermostats, processors, alarms, shutoffs, additional valving, etc., and that can further include attendant processors, hardware and software, etc. to monitor, control, regulate, and/or alter one of more features of the aircraft cargo compartment (air) temperature regulating system either manually, automatically, remotely, etc. The addition of controllers, sensors, thermostats, actuators, alarms, “fail safes”, etc., to the present systems can be in communication with readouts and/or can be in communication with automated electrical circuits to, for example, monitor and adjust temperatures of the airflow at one or more points along and throughout the present system, such that the airflow characteristics (e.g., temperature, velocity, etc.) and the warmed fluid characteristics (temperature, velocity, etc.) can be monitored in real time.

For example, if a temperature deviation from expected values arises and is detected, the configured and incorporated monitoring devices, and supporting software/hardware/ processors can be configured to initiate and control actions on the warmed fluid flow and warmed airflow and to alter airflow and/or warmed fluid velocities, for the purpose of, for example, returning a sensed cargo compartment temperature value to a selected optimal operating temperature, etc. Peripheral sensors, detectors, etc., can further include routine system “checks” on the components of the circuits (e.g., pump performance, system pressure, heat exchange performance, chiller performance, etc.) that can occur at scheduled maintenance intervals as well as occurring at throughout a flight, and further including a continuous system monitoring in real time and on demand that can, for example, include leakage detection, as well as temperature variation, etc., and/or indicate equipment faults to appropriate users of such data in real time and on demand.

The term “substantially” as used herein means that a particular characteristic, parameter, or value does not need to be exactly achieved. Rather, deviations or variations, including, for example, tolerances, measurement error, measurement accuracy limitations, dimensions, and other factors known to those skilled in the field, may occur in amounts that do not preclude the effect that the characteristic was intended to provide.

The present aspects may, of course, be carried out in other ways than those specifically set forth herein without departing from essential characteristics of the present disclosure. The present aspects are to be considered in all respects as illustrative and not restrictive, and all changes coming within the meaning and equivalency range of the appended claims and are intended to be embraced therein.

What is claimed is:

1. An aircraft cargo compartment temperature regulating system for directing waste heat from an aircraft liquid chilling circuit to an aircraft cargo compartment, said aircraft cargo compartment temperature regulating system comprising:
an aircraft liquid chilling circuit for providing chilling to a first aircraft region to reduce an environmental temperature in the first aircraft region, said aircraft liquid chilling circuit configured to provide absorbed waste heat from the first aircraft region to form a warmed liquid flow in a warmed liquid flow line in the aircraft liquid chilling circuit;
a heat exchanger located in line with the aircraft liquid chilling circuit, said heat exchanger comprising a heat exchanger liquid inlet in communication with the warmed liquid flow line, said heat exchanger further comprising a cooler liquid heat exchanger outlet in communication with a cooler liquid flow line in the aircraft liquid chilling circuit, said heat exchanger further comprising a heat exchanger air inlet and a heat exchanger warmed air outlet, said heat exchanger configured to transfer waste heat in the warmed liquid flow to an airflow entering the heat exchanger air inlet; and
an aircraft cargo compartment air duct in communication with an aircraft cargo compartment, said aircraft cargo compartment air duct further in communication with heat exchanger warmed air outlet, said heat exchanger located upstream of the aircraft cargo compartment air duct.

2. The aircraft cargo compartment temperature regulating system of claim 1, further comprising:
an air temperature sensor located in the aircraft cargo compartment;
a controller in communication with the air temperature sensor; and
a heated airflow valve assembly in communication with the controller, said heated airflow valve assembly in communication with the heat exchanger, said heat exchanger comprising a liquid-to-air heat exchanger, said heated airflow valve assembly configured to control release of a warmed airflow from a warmed airflow line in communication with the heat exchanger warmed air outlet into an aircraft cargo compartment air duct in response to a temperature sensed by the air temperature sensor, and in further response to a signal sent by the controller.

3. The aircraft cargo compartment temperature regulating system of claim 1, further comprising:
a cargo compartment air temperature sensor located in the aircraft cargo compartment;
a liquid valve controller in communication with the cargo compartment air temperature sensor; and
a liquid valve assembly in communication with the warmed liquid flow line, said liquid valve assembly located upstream of the heat exchanger liquid inlet, said liquid valve assembly further in communication with the liquid valve controller, said liquid valve assembly configured to control delivery of a warmed liquid flow from the warmed liquid flow line into the heat exchanger liquid inlet in response to a temperature sensed by the cargo compartment air temperature sensor, and in further response to a signal sent by the liquid valve controller to the liquid valve assembly.

4. The aircraft cargo compartment temperature regulating system of claim 3, further comprising:
a heated airflow valve assembly in communication with a heated airflow valve controller, said heated airflow valve assembly located downstream of the heat exchanger, said heated airflow valve assembly configured to control passage of a warmed airflow from the heat exchanger into an aircraft cargo compartment in response to a temperature sensed by the cargo compartment air temperature sensor, and in further response to a signal sent by the heated airflow valve controller.

5. The aircraft cargo compartment temperature regulating system of claim 1, wherein the first aircraft region is at least one of an electronics compartment, electrical equipment, electronics assemblies, and a galley compartment.

6. The aircraft cargo compartment temperature regulating system of claim 1, wherein said aircraft liquid chilling circuit circulates a fluid configured to absorb and release a thermal load, said fluid comprising at least one of a propylene glycol mixture, a perfluoropolyether mixture, water, and combinations thereof.

7. The aircraft cargo compartment temperature regulating system of claim 4, wherein the heated airflow valve assembly is located within the aircraft cargo compartment air duct.

8. The aircraft cargo compartment temperature regulating system of claim 4, wherein at least one of the liquid valve controller and the heated airflow controller is configured to receive an aircraft condition signal, said aircraft condition signal comprising at least one of a aircraft phase of flight signal, an aircraft altitude signal, and an aircraft cargo compartment selected temperature signal.

9. The aircraft cargo compartment temperature regulating system of claim 1, wherein waste heat from the air liquid chilling circuit is delivered to the heat exchanger to form a heated airflow responsible for regulating air temperature within the aircraft cargo compartment.

10. The aircraft cargo compartment temperature regulating system of claim 1, wherein the aircraft cargo compartment air duct is not in communication with another heat generating assembly.

11. An aircraft cargo compartment in communication with the aircraft cargo compartment temperature regulating system of claim 1.

12. An aircraft comprising the aircraft cargo compartment temperature regulating system of claim 1.

13. A method for regulating air temperature in an aircraft cargo compartment, the method comprising:
directing an onboard liquid chilling circuit to an aircraft first region, said onboard liquid chilling circuit configured to provide cooling to the aircraft first region, said onboard liquid chilling circuit further configured to capture heat from the aircraft first region and direct captured heat from the aircraft first region away from the aircraft first region in a warmed liquid flow in the onboard liquid chilling circuit;
directing the warmed liquid flow to a heat exchanger warmed liquid inlet of the heat exchanger;
directing an airflow to a heat exchanger airflow inlet of the heat exchanger;
generating a warmed airflow at the heat exchanger; and
directing the warmed airflow from a heat exchanger warmed airflow outlet to an aircraft cargo compartment via an aircraft cargo compartment air duct, said aircraft cargo compartment air duct in communication with the aircraft cargo compartment.

14. The method of claim 13, further comprising:
actuating a warmed liquid valve positioned upstream of the heat exchanger to regulate entry of the warmed liquid flow from a warmed liquid flow line into the heat exchanger liquid inlet.

15. The method of claim 13, further comprising:
actuating a warmed airflow valve positioned downstream of the heat exchanger and further positioned upstream of the aircraft cargo compartment to regulate entry of the warmed airflow from the heat exchanger warmed air outlet into the aircraft cargo compartment.

16. The method of claim 14, further comprising;
sending an aircraft cargo compartment air temperature sensor signal from an aircraft cargo compartment air temperature sensor to a liquid valve controller; and
sending a controller signal from the liquid valve controller to the warmed liquid valve to actuate the warmed liquid valve in response to the aircraft cargo compartment air temperature sensor signal received by the controller.

17. The method of claim 15, further comprising;
sending an aircraft cargo compartment air temperature sensor signal from an aircraft cargo compartment air temperature sensor to a warmed airflow controller; and
sending a controller signal from the warmed airflow controller to the warmed airflow valve to actuate the warmed airflow valve in response to the aircraft cargo compartment air temperature sensor signal received by the warmed airflow controller.

18. The method of claim 16 further comprising:
regulating an aircraft cargo compartment air temperature by directing waste heat absorbed from an aircraft first region to the aircraft cargo compartment via the onboard liquid chilling circuit, wherein the aircraft cargo compartment air duct is not in communication with another heat generating assembly.

19. The method of claim 17 further comprising:
regulating an aircraft cargo compartment air temperature by directing waste heat absorbed from an aircraft first region to the aircraft cargo compartment air duct via the onboard liquid chilling circuit, wherein the aircraft cargo compartment air duct is not in communication with another heat generating assembly.

20. A method for regulating air temperature in an aircraft cargo compartment of an aircraft, the method comprising:
installing into an aircraft, an aircraft cargo compartment temperature regulating system for directing waste heat from an aircraft liquid chilling circuit to an aircraft cargo compartment comprising, said aircraft cargo compartment temperature regulating system:
an aircraft liquid chilling circuit configured to provide chilling to a first aircraft region to reduce an environmental temperature in the first aircraft region, said aircraft liquid chilling circuit further configured to provide absorbed waste heat from the first aircraft region to form a warmed liquid flow in a warmed liquid flow line in the aircraft liquid chilling circuit;
a heat exchanger located in line with the aircraft liquid chilling circuit, said heat exchanger comprising a heat exchanger liquid inlet in communication with the warmed liquid flow line, said heat exchanger further comprising a cooler liquid heat exchanger outlet in communication with a cooler liquid flow line in the liquid chilling circuit, said heat exchanger further comprising a heat exchanger air inlet and a heat exchanger warmed air outlet, said heat exchanger configured to transfer waste heat in the warmed liquid flow to an airflow entering the heat exchanger air inlet; and
an aircraft cargo compartment air duct in communication with an aircraft cargo compartment, said aircraft cargo compartment air duct further in communication with heat exchanger warmed air outlet, said heat exchanger located upstream of the aircraft cargo compartment air duct.
